(19) United States
(12) Patent Application Publication
(10) Pub. No.: US 2005/0050494 A1
(43) Pub. Date: Mar. 3, 2005

(54) Power estimation based on power characterizations of non-conventional circuits

(76) Inventors: Tyson R. McGuffin, Fort Collins, CO (US); Thomas W. Chen, Fort Collins, CO (US); Samuel D. Naffziger, Fort Collins, CO (US); Eric S. Fetzer, Longmont, CO (US)

Correspondence Address: HEWLETT-PACKARD COMPANY;Intellectual Property Administration, P.O. Box 272400, Fort Collins, CO, 80527-2400, US

(21) Appl. No.: 10/653,328

(22) Filed: Sep. 2, 2003

(51) Int. Cl. G06F 9/45

(52) U.S. Cl. 716/5

(57) ABSTRACT

Systems and methods are provided that can be utilized to estimate power associated with a circuit design. The estimated power is determined by employing power characterizations to determine power consumption associated with non-conventional circuits in the circuit design. The power characterizations can be determined prior to circuit design timing analysis, stored and utilized during circuit design timing analysis. The power estimates associated with the non-conventional circuits can be added to power estimates associated with the conventional circuits of the circuit design to compute a power associated with the circuit design.

### CROSS REFERENCE TO RELATED APPLICATIONS

The present application is related to Tyson R. McGuffin, et al. U.S. Patent Application entitled “Power Estimation Based on Power Characterizations”, Filed Aug. 29, 2003, Attorney Docket No. 200208595-1, which is assigned to the same assignee as the present application and which is incorporated herein by reference.

### TECHNICAL FIELD

The present invention relates to circuit analysis and, more particularly, to an approach to estimate power consumption of a circuit design employing power characterizations for non-conventional circuits.

### BACKGROUND OF INVENTION

Power consumption is becoming an increasing concern in the design of integrated circuits (ICs), particularly for very large scale integration (VLSI) chip design. Increases in power consumption are outpacing the advantages of advances in scaling in silicon technologies. To address this concern, many computer-aided design (CAD) tools or analysis tools have been developed to measure or estimate power consumption in VLSI designs. These tools for example provides for system level design, verification, analysis and simulated testing of register-transfer level (RTL) designs, gates and physical layout structures. The estimated power consumption is employed to help designers meet target power parameters and ultimately facilitate design convergence.

However, power consumption is often overlooked for non-conventional circuits associated with a respective circuit design or portions of a circuit design. Non-conventional circuits are special cases that are not readily simulated by standard analysis tools. For example, a non-conventional circuit can be a circuit that has a very low input capacitance, but can drive a large load (e.g., a clock gater). Additionally, a non-conventional circuit can be a logic circuit that employs logic contention or drive-fight, which is difficult to simulate. For certain non-conventional circuit structures, the accurate calculation of circuit power is especially complex and time consuming.

### SUMMARY OF INVENTION

The present invention relates generally to systems and methods to estimate power consumption associated with a circuit design. One embodiment of the present invention provides a power estimation system that employs power characterizations to estimate power associated with one or more non-conventional circuits of a circuit design. The power estimates associated with the one or more non-conventional circuits can be added to the power estimates associated with conventional circuits of the circuit design to provide a total power estimate. In another embodiment of the invention, a power estimation engine is employed that utilizes characterizations associated with non-conventional circuits, and characterizations associated with conventional circuits to compute power associated with a circuit design.

### BRIEF DESCRIPTION OF THE DRAWINGS

FIG. 1 illustrates a block diagram of a system for estimating power in accordance with an embodiment of the present invention.

FIG. 2 illustrates a block diagram of a system for estimating power in accordance with another embodiment of the present invention.

FIG. 3 illustrates a block diagram of a system for determining a functional relationship of power to output drive load associated with non-conventional circuits in accordance with an embodiment of the present invention.

FIG. 4 illustrates a scatter plot of power versus output drive load in accordance with an embodiment of the present invention.

FIG. 5 illustrates a block diagram of a system for determining total source-to-drain leakage in accordance with an embodiment of the present invention.

FIG. 6 illustrates a block diagram of a system for determining total gate tunneling leakage in accordance with an embodiment of the present invention.

FIG. 7 illustrates a block diagram of a system for determining total crossover current in accordance with an embodiment of the present invention.

FIG. 8 illustrates a block diagram of a system for determining total switching capacitance in accordance with an embodiment of the present invention.

FIG. 9 illustrates a block diagram of a system for determining total power associated with non-conventional circuits in accordance with an embodiment of the present invention.

FIG. 10 illustrates a block diagram of yet another system for estimating power in accordance with an embodiment of the present invention.

FIG. 11 is a flow diagram illustrating a methodology for characterizing non-conventional and conventional circuits of a circuit design in accordance with an embodiment of the present invention.

FIG. 12 is a flow diagram illustrating a methodology for estimating power in accordance with an embodiment of the present invention.

### DETAILED DESCRIPTION

The present invention relates generally to systems and methods that can be utilized to estimate power (e.g., associated with a circuit design). The estimated power is determined by employing power characterizations to determine power consumption associated with one or more non-conventional circuits associated with a circuit design. The power characterizations can be determined prior to circuit design timing analysis, stored and utilized during circuit design timing analysis. The power estimate associated with the non-conventional circuits can be added to a power estimate associated with one or more conventional circuits in the circuit design. A variety of different techniques can be employed to determine a power estimate associated with conventional circuits in the circuit design.

Non-conventional circuits are circuits that are ignored by most circuit design analysis tools (e.g., timing tools, power estimation tools, optimization tools) due to the complexities associated with simulating a non-conventional circuit. For example, circuits that purposefully employ drive-fight or logic contention are generally difficult to simulate and, thus, ignored by most circuit design analysis tools. Drive fight or logic contention is when one transistor (or transistor network) is driving a node to a first voltage level (e.g., VDD) and another transistor (or transistor network) is driving the node to a second voltage level (e.g., GND), where the stronger (widest) of the two transistors or transistor networks will drive the node overriding the weaker transistor or transistor network.

One type of non-conventional circuit design is referred to as a clock gater. A clock gater is a circuit which receives a first clock signal and outputs a second clock signal that is a function of the input clock signal. The clock gater is used to drive clocked logic gates, which perform a function in response to an assertion or deassertion of a clock signal. Typically, a clock gater receives a system clock signal. Therefore, the clock gater is designed to have a low input capacitance, so as not to overload the system clock. A clock gater might perform some function on the clock signal, such as adjusting the pulse width or frequency, so that the output clock signal has different characteristics than the input clock signal. The clock gater is also designed to have high current drive capabilities to drive clock enabled logic gates. This type of circuit is also difficult to simulate and ignored by most analysis tools. It is to be appreciated that other non-conventional circuit types would be apparent to those skilled in the art

The power estimates based on power characterizations for non-conventional and conventional circuits can be computed for a circuit design. A circuit design can correspond to a node or other juncture between adjacent components, structures or blocks, as well as a circuit component, a functional or structural block, channel connected regions or any combination thereof.

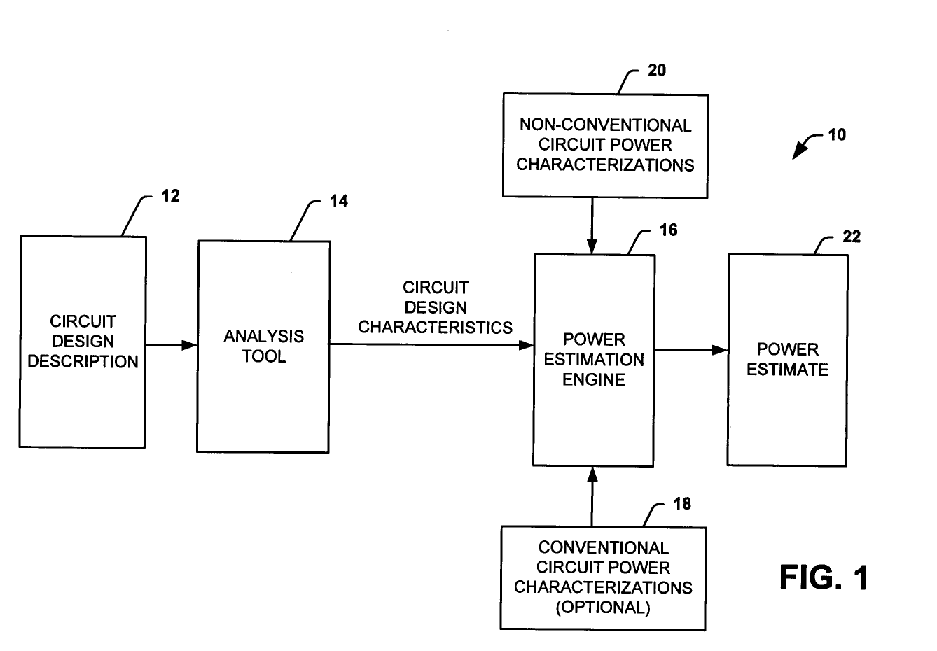

FIG. 1 illustrates an analysis system 10 that can be implemented to estimate power in accordance with an embodiment of the present invention. The system 10 can be a computer, a server or some other computer readable medium that can execute computer executable instructions. The analysis system 10 includes a power estimation engine 16 that utilizes circuit design characteristics and non-conventional circuit power characterizations 20 to estimate power associated with non-conventional circuits of a circuit design. In one embodiment of the present invention, the power estimation engine 16 employs one or more conventional circuit power characterizations 18 associated with conventional circuits of the circuit design. The conventional circuit power characterizations can be employed to determine dynamic and/or static power associated with conventional circuits in the circuit design.

The one or more non-conventional circuit power characterizations 20 are predetermined by analyzing circuit design characteristics associated with a circuit design description 12, prior to execution of the power estimation engine 16. The analysis can be performed by one or more circuit design analysis tools. For example, spice characterizations can be employed to determine power consumption based on output load of a given non-conventional circuit type. A number of power and associated load values can be determined and analyzed to determine a relationship of power as a function of output load for one or more non-conventional circuit types. The functional relationship can be based on one or more power coefficients and/or equations (e.g., linear, polynomial, logarithmic, exponential, etc.) that can be employed to determine power as a function of output load for a given non-conventional circuit type (e.g., a clock gater).

The one or more power coefficients and/or equations can be pre-stored based on non-conventional circuit type, for example, in non-conventional circuit characteristics library (not shown). The one or more power coefficients and/or equations can be accessed during execution of the power estimation engine 16. The power estimation engine 16 can determine the output load or capacitance of a given non-conventional circuit via circuit design characteristics generated by an analysis tool 14 (e.g., a static timing tool). The power estimation engine 16 can employ the predetermined one or more power coefficients and/or equations to evaluate a power estimate for the given non-conventional circuit. This can be repeated for each non-conventional circuit in the circuit design, and summed up to provide a total power associated with non-conventional circuits in the circuit design.

Optionally, conventional circuit power characterizations 18 can be predetermined and pre-stored for access during execution of the power estimation engine 16. The conventional circuit power characterizations 18 can be determined employing one or more analysis tools to derive a relationship of power related parameters to circuit design characteristics associated with conventional circuits. The conventional circuit power characterizations can include separate dynamic power characterizations and/or static power characterizations to generate power related parameters associated with dynamic and/or static power consumption of conventional circuits associated with a given design instance.

The analysis system 10 employs the circuit design description 12 to provide information to an analysis tool 14. The design description 12 can include transistor netlists, design netlists, design parasitic data and timing constraints associated with the circuit design. The analysis tool 14 executes a device modification and timing algorithm to optimize a circuit design. For example, the analysis tool 14 can be a static timing analysis tool (e.g., PATHMILL™ by Synopsys) for block and chip timing verification. A static timing analysis tool will generate a plurality of circuit design instances that correspond to device changes (e.g., transistor sizing, cell device modifications) based on timing and delay analysis to optimize the circuit design based on speed, power and area. Alternatively, the analysis tool 14 can be a transistor autosizer (e.g., AMPS™ by Synopsys). Most transistor autosizers rely on heuristic approaches that focus on finding the best combination that will meet user-defined power and speed goals without changing the functionality of the design. The transistor autosizers employ an original circuit design description to generate a plurality of circuit sizing instances that define different optimized cell netlist configurations.

The analysis tool 14 performs timing analysis, transistor sizing optimization, device modifications and/or power analysis on the circuit design description. The analysis tool 14 executes timing analysis and modifies transistor sizes and/or circuit cell configurations to optimize the circuit design without disturbing the functionality associated with the circuit design. The analysis tool 14 then generates one or more circuit design characteristics for each associated circuit design instance. The circuit design instance relates to characteristics associated with the new optimized design. The circuit design characteristics will change for each instance, while the predetermined power characterizations will remain fixed during execution of the analysis tool 14. The power estimation engine 16 then determines a power estimate 22 of the circuit design instance based on the predetermined power characterizations 18, 20 and generated circuit design characteristics.

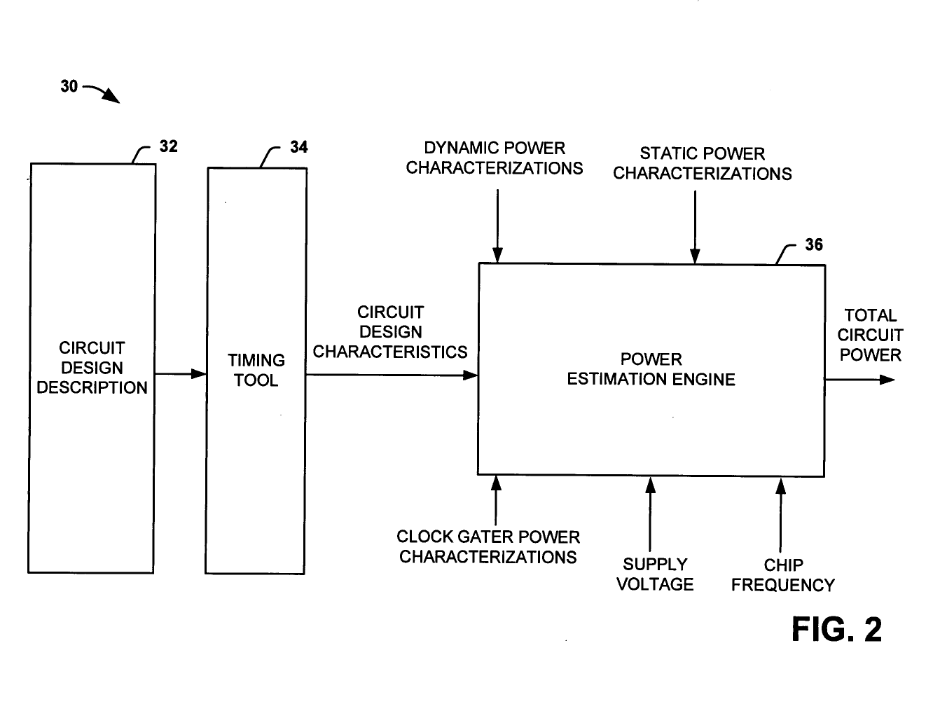

FIG. 2 illustrates an analysis system 30 that can be implemented to estimate power in accordance with another embodiment of the present invention. The analysis system 30 includes a power estimation engine 36 that utilizes circuit design characteristics and power characterizations to estimate power associated with a circuit design. The power estimation engine 36 employs dynamic power characterizations and static power characterizations to determine dynamic and/or static power associated with conventional circuits in the circuit design. The power estimation engine 36 also employs clock gater power characterizations to determine power associated with clock gater devices or cells in the circuit design. It is to be appreciated that the present example illustrates power estimation for clock gater devices, but could include power estimation for other non-conventional circuit types.

The power estimation engine 36 utilizes predetermined clock gater power characterizations and clock gater output loads to provide a power estimate associated with clock gaters. The clock gater power characterizations are predetermined by analyzing power consumption associated varying output loads for one or more clock gater types. A type of clock gater can be defined based on the devices and/or number of devices that a clock gater will drive. A functional relationship is then determined between device power and output load for each of the gater types. This functional relationship can be employed to determine clock gater power characterizations.

The clock gater output loads are derived from circuit design characteristics generated by the timing tool 34. For example, the clock gater output loads can be derived by parsing a node capacitance list to determine the node capacitance associated with the output of a clock gater. The node capacitance can include fanout (multiple device connections) considerations based on the number of devices being driven by the clock gater. The predetermined characterization for that specific clock gater type is then employed with the derived load capacitance to determine a power estimate for a given clock gater. This is repeated for each clock gater to determine overall power consumption attributed to clock gaters of a circuit design.

Additionally, conventional circuit characterizations (i.e., dynamic power characterizations, static power characterizations) can be predetermined and pre-stored for access during execution of the power estimation engine 36. The conventional circuit design characteristics and associated power consumption can be analyzed employing one or more analysis tools to determine power characterizations that functionally relate power related parameters to power consumption. The conventional circuit power characterizations can include separate dynamic power characterizations and static power characterizations to generate power related parameters associated with dynamic and static power consumption of conventional circuitry associated with a design instance.

In one embodiment of the present invention, the power estimation engine 36 employs the circuit design characteristics and the dynamic power characterizations and/or static power characterizations to generate power related parameters associated with dynamic and/or static power consumption of conventional circuits associated with a given circuit design instance. The power estimation engine 36 evaluates total conventional circuit power based on the power related parameters, chip supply voltage and chip frequency of the circuit design.

For example, the dynamic power estimates can be based on switching power losses that include switching capacitance losses and/or crossover current losses. Therefore, switching capacitance and/or crossover current are dynamic power related parameters that can be determined to evaluate dynamic power loss. The static power losses can be associated with device leakage associated with transistor tunneling gate losses and/or source-to-drain leakage losses. Therefore, transistor tunneling gate losses and source-to-drain leakage losses are static power related parameters that can be determined to evaluate leakage power loss.

The analysis system 30 utilizes the circuit design description 32 to provide information to a timing tool 34. The design description 32 can include transistor netlists, design netlists, design parasitic data and timing constraints associated with the circuit design. The timing tool 34 executes a device modification and timing algorithm to optimize a circuit design. For example, the timing tool 34 can be a static timing analysis tool (e.g., PATHMILL™ by Synopsys) for block and chip timing verification. A static timing analysis tool will generate a plurality of circuit design instances that correspond to device changes (e.g., transistor sizing, cell device modifications) based on timing and delay analysis to optimize the circuit design based on speed, power and area.

The timing tool 34 generates one or more circuit design characteristics for each associated circuit design instance. The circuit design instance relates to characteristics associated with the new optimized design. The circuit design characteristics will change for each instance, while the predetermined power characterizations will remain fixed during execution of the timing tool 34. The power estimation engine 36 determines a total circuit power estimate of the circuit design instance based on the predetermined power characterizations for both conventional circuits and non-conventional clock gater circuits and generated circuit design characteristics for a given circuit design instance. The power associated with the non-conventional clock gater circuits is then added to the power estimate of the conventional circuits to generate a total circuit power for a given circuit design instance.

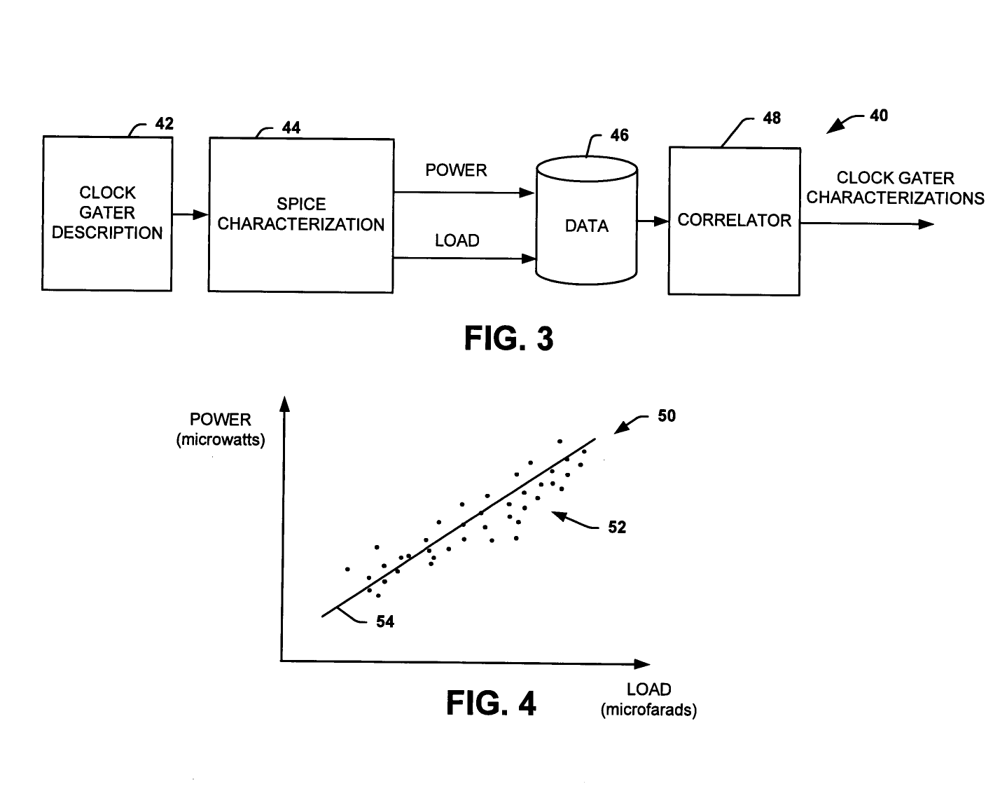

FIG. 3 illustrates a system 40 for correlating power with clock gater output load in accordance with an embodiment of the present invention. The system 40 includes a spice characterization 44 associated with a clock gater description 42 for a plurality of clock gater types. The spice characterization 44 is employed to determine power consumption for respective clock gaters based on output load for a plurality of output loads. Power and associated load data are then stored in a database 46 for further analysis for each of the plurality of clock gater types. A correlator 48 determines an associated relationship between the power estimate data and the output drive load of the plurality of clock gater types. The correlator 48 then determines a functional relationship between power and ouput drive load for each of the clock gater types.

The functional relationship is employed to generate clock gater characterizations associated with each of the clock gater types. For example, by applying a regression technique (e.g., least means square, parametric regression, non-parametric regression) to the output drive load and associated power data stored in the database 46 to derive one or more power coefficients and/or equations that functionally relate output driver load to power. The one or more power coefficients and/or equations can be employed with evaluated output driver loads associated with a given circuit design instance to perform efficient relative power estimates of clock gater circuits.

FIG. 4 illustrates a scatter plot 50 of power (microwatts) versus output drive load (microfarads) for power estimation data 52 in accordance with an embodiment of the present invention. The power estimation data 52 can be generated by analyzing a spice characterization of an associated clock gater with varying output loads. This is repeated for each clock gater type to generate a respective scatter plot associated with each of a plurality of clock gater types. For illustrative purposes, the scatter plot 50 illustrates a linear relationship between output drive load and power associated with a given clock gater type. However, it is to be appreciated that a variety of different functional relationships (e.g., linear, polynomial, logarithmic, exponential, etc.) could be determined for a given clock gater type. The scatter plot 50 is analyzed to determine a functional relationship between output drive load and power for a given clock gater type.

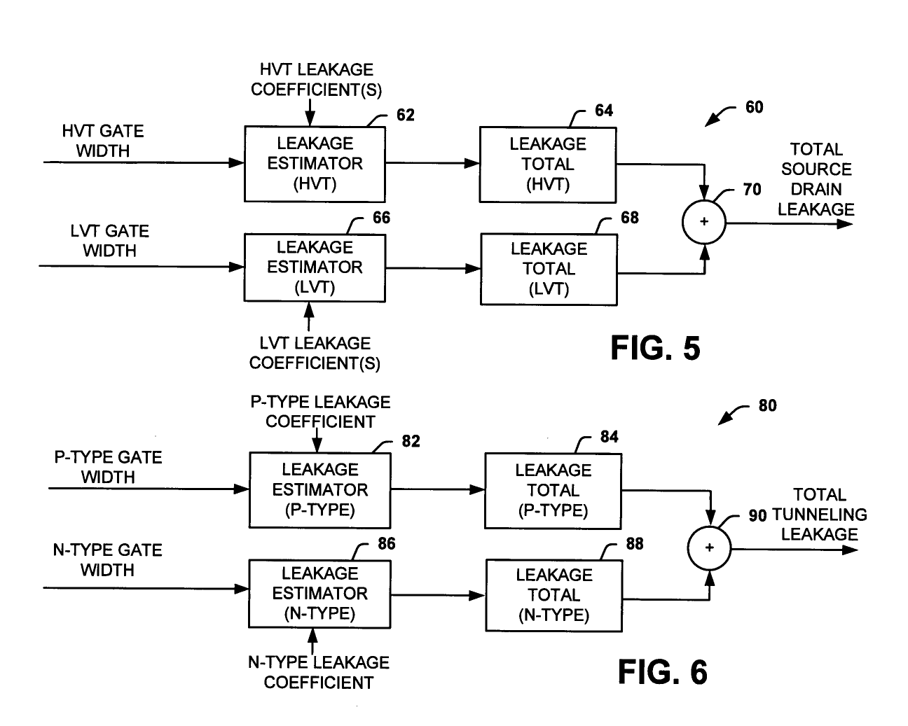

FIGS. 5-8 illustrates systems for determining power related parameters employing power characterizations associated with conventional circuits of a circuit design. Both dynamic power related parameter(s) and static power related parameter(s) are illustrated employing dynamic power characterizations and static power characterizations, respectively. The power characterizations can be determined and stored prior to circuit design optimizations, and utilized during circuit design optimizations for one or more circuit design instances. It is to be appreciated that the dynamic and static power characterizations can be determined employing a variety of analysis techniques. Several such analysis techniques are illustrated in commonly assigned McGuffin et al., U.S. Patent application entitled “Power Estimation Based on Power Characterizations” Attorney Docket No. 200208595-1, the entire contents of which is incorporated herein by reference.

FIG. 5 illustrates a system 60 for determining total source-to-drain leakage associated with conventional circuits of a circuit design in accordance with an embodiment of the present invention. The system 60 includes a first leakage estimator 62 (HVT) that determines source-to-drain leakage associated with HVT devices of the conventional circuits, and a second leakage estimator 66 (LVT) that determines source-to-drain leakage associated with LVT devices of the conventional circuits. The first estimator 62 employs the HVT gate width associated with the HVT devices and one or more HVT leakage coefficients to determine a total HVT leakage current 64 associated with the source-to-drain leakage of HVT devices of conventional circuits in the circuit design. The total HVT leakage current 64 can be determined by evaluating the leakage associated with each device employing the HVT leakage coefficients to provide incremental leakage calculations that can be totaled together. Alternatively, the leakage can be evaluated by determining the sum of all of the HVT device gate areas and employing the HVT coefficients to determine the total HVT leakage 64. The HVT leakage coefficients can be one or more multipliers and/or offset coefficients that can be multiplied and/or added to the HVT gate widths to provide a source-to-drain leakage estimate with respect to HVT devices.

The second estimator 66 employs the LVT gate width associated with the LVT devices of conventional circuits in the circuit design and one or more LVT leakage coefficients to determine a total LVT leakage current 68 associated with the source-to-drain leakage of LVT devices. The total LVT leakage 68 can be determined by evaluating the leakage associated with each LVT device employing the LVT leakage coefficients to provide incremental leakage calculations that can be totaled together. Alternatively, the leakage can be evaluated by determining the sum of all of the LVT device gate areas and employing the LVT coefficients to determine the total LVT leakage 68. The LVT leakage coefficients can be one or more multipliers and/or offset coefficients that can be multiplied and/or added to the LVT gate width to provide a source-to-drain leakage estimate with respect to LVT devices. The total HVT leakage 64 and the total LVT leakage 68 can be summed together via an adder 70 to provide the total source-to-drain leakage associated with conventional circuits of the circuit design.

FIG. 6 illustrates a system 80 for determining total gate tunneling leakage of conventional circuits of a circuit design in accordance with an embodiment of the present invention. The system 80 includes a first p-type leakage estimator 82 that determines gate tunneling leakage associated with p-type devices associated with conventional circuits, and a second n-type leakage estimator 86 that determines gate tunneling leakage associated with n-type devices associated with conventional circuits. The first p-type leakage estimator 82 utilizes the p-type gate widths associated with the p-type devices in the circuit design, and one or more p-type leakage coefficients to determine a total p-type leakage current 84 associated with the gate tunneling leakage of p-type devices associated with conventional circuits in the circuit design. The total p-type leakage current 86 can be determined by evaluating the leakage associated with each p-type device employing the p-type leakage coefficients to provide incremental leakage calculations that can be totaled together. Alternatively, the leakage can be evaluated by determining the sum of all of the p-type device gate areas and employing the p-type coefficients to determine the p-type leakage total 84. The p-type leakage coefficients can be one or more multipliers and/or offset coefficients that can be multiplied and/or added to the p-type gate widths to provide a gate tunneling leakage estimate associated with p-type devices associated with conventional circuits of the circuit design.

The second n-type leakage estimator 86 utilizes the n-type device gate widths associated with the n-type devices of conventional circuits of the circuit design, and one or more n-type leakage coefficients to determine an n-type leakage total 88 associated with the gate tunneling leakage of n-type devices. The total n-type leakage can be determined by evaluating the leakage associated with each n-type device employing the n-type leakage coefficients to provide incremental leakage calculations that can be totaled together to provide the n-type leakage total 88. Alternatively, the leakage can be evaluated by determining the sum of all of the n-type device gate areas and employing the n-type coefficients to determine the n-type leakage total 88. The n-type leakage coefficients can be one or more multipliers and/or offset coefficients that can be multiplied and/or added to the n-type gate widths to provide a gate tunneling leakage estimate for n-type devices. The total p-type leakage 84 and the total n-type leakage 88 can be summed together via an adder 90 to provide the total gate tunneling leakage associated with conventional circuits of the circuit design. The total gate tunneling leakage can be added to the total source gate leakage to provide a total leakage current associated with conventional circuits of the circuit design.

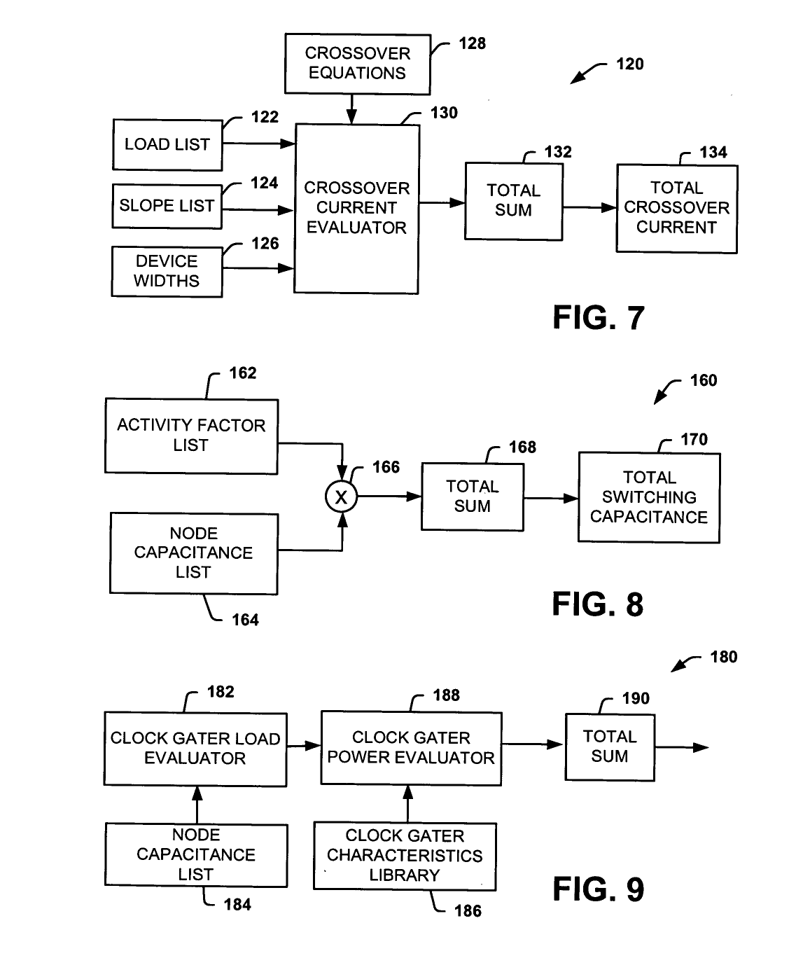

FIG. 7 illustrates a system 120 for determining a total crossover current associated with conventional circuits of a circuit design in accordance with an embodiment of the present invention. The crossover current relates to power losses associated with transistors, inverters and other circuits associated with conventional circuits of the circuit design that temporarily short circuit the voltage supply to ground during logic transitions. The system 120 employs a crossover current evaluator 130 that utilizes predetermined crossover equations 128 to determine crossover currents associated with transistors and/or transistor devices of conventional circuits in the circuit design. The crossover equations 128 are employed to determine crossover currents for transistors and/or transistor devices (e.g., inverters) employing a plurality of circuit design characteristics generated by a static timing analysis tool or similar simulation/optimization tool.

The crossover current evaluator 130 receives an input voltage slope list 124, a capacitive load list 122 and a device widths list 126 associated with transistors and/or transistor devices (e.g., channel connected regions) based on a given circuit instance. The crossover current evaluator 130 determines a crossover current for each channel connected region by employing a device width, a load, a slope, and an associated equation for a respective channel connected region. Each crossover current is provided to a summer 132 that sums up the determined crossover currents to provide a total crossover current 134 for an associated circuit design instance.

The device widths can be widths associated with each channel connected region in the circuit design. This width can be an actual width as determined, for example, by CAD software, or an estimated width. For example, the width can be estimated by summing the width of each MOSFET in a set of parallel MOSFETs. Alternatively, the width can be estimated by combining the widths of two MOSFETs in series by dividing one by a sum of one divided by the width of the first serial MOSFET and one divided by the width of the second serial MOSFET. The width can be also be estimated by similar combinations of previously estimated MOSFET widths.

FIG. 8 illustrates a system 160 for determining a total switching capacitance associated with conventional circuits in a circuit design in accordance with an embodiment of the present invention. The system 160 employs an activity factor list 162 than can be determined employing one or more analysis tools. The system 160 also utilizes a node capacitance list 164 that can be generated by a static timing analysis tool. The system 160 extracts an activity factor and a node capacitance associated with a given node. The node capacitance is multiplied by a node activity factor via a multiplier 166 to provide a respective node switching capacitance. The respective node capacitance is then provided to a summer 168 that sums the switching capacitance for each node to provide a total switching capacitance 170. The total switching capacitance 170 can be employed to determine switching power consumption.

FIG. 9 illustrates a system 180 for determining power associated with clock gater devices (non-conventional circuits) in accordance with an embodiment of the present invention. The system 180 employs a node capacitance list 184 that can be generated by a static timing analysis tool. A clock gater load evaluator 182 determines capacitive loads associated with one or more clock gater devices employing information associated with the node capacitance list 184. For example, a capacitive load associated with a clock gater can include a single node capacitance that the clock gater will drive. Alternatively, load capacitances associated with fanouts (connections to multiple devices) coupled to the clock gater output can be employed to determine the capacitive load associated with a respective clock gater. The clock gater load evaluator 182 then provides the determined load associated with each of the one or more clock gaters to a clock gater power evaluator 188.

The clock gater power evaluator 188 receives information regarding the type of clock gater and the capacitive load associated with the respective clock gater for each of the clock gaters. The clock gater power evaluator 188 then extracts clock gater characteristics (e.g., coefficients, equations) associated with a given clock gater type for each clock gater types from a clock gater characteristics library 186. The clock gater type characteristics and the capacitive load associated with a given clock gater are utilized to determine a power estimate for the respective clock gater. The power estimates for each clock gater are provided to a summer 190 that sums the power estimates for each clock gater to provide a total power estimate for the clock gaters. It is to be appreciated that although the present example is illustrated for determining power consumption associated with clock gaters, the system can be employed to determine power consumption for other non-conventional circuit devices.

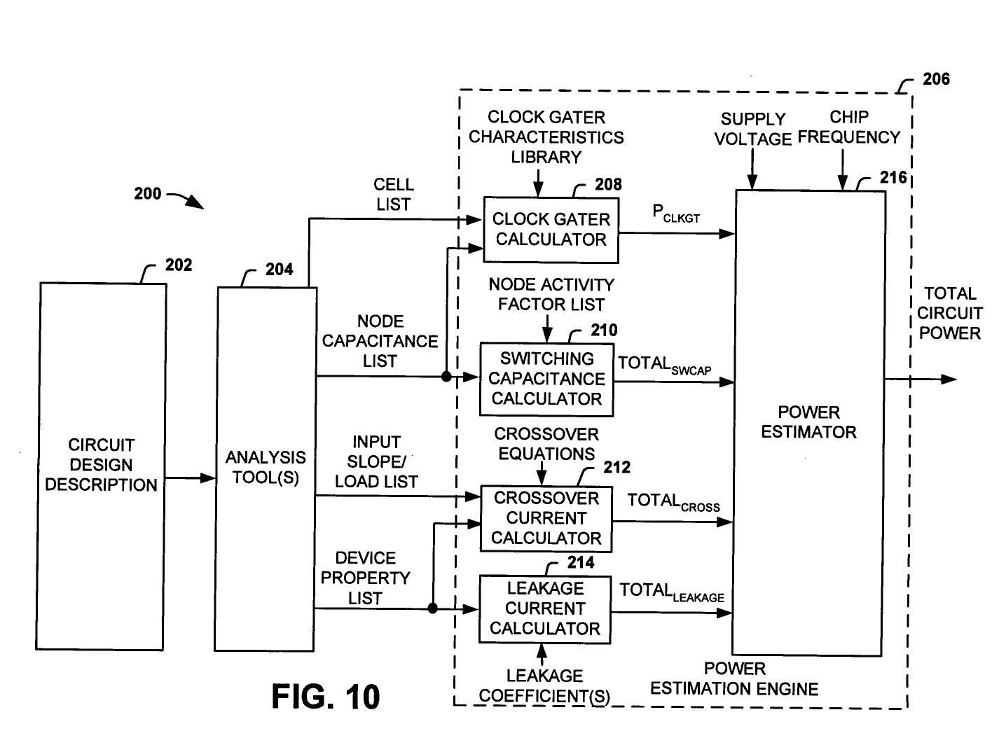

FIG. 10 illustrates a system 200 that can be implemented to estimate power in accordance with another embodiment of the present invention. The system 200 includes a power estimation engine 206 that performs power estimation for both conventional and non-conventional circuits in a circuit design. Power estimation for conventional circuits is based on both static power estimates and dynamic power estimates. The dynamic power estimates are based on both switching power and crossover current power consumption. The static power estimates are based on leakage power estimates. The power estimation engine 206 utilizes one or more power characterizations associated with switching power, crossover current power and leakage power to determine power associated with conventional circuitry of a circuit design. The power estimation engine 206 employs one or more power characterizations associated with clock gater power (a non-conventional circuit) of a circuit design. The one or more power characterizations are pre-determined by analyzing characteristics associated with a circuit design description 202 prior to execution of the power estimation engine 206. The one or more power characterizations are then stored to be utilized to determine power estimates for a plurality of circuit design instances.

The circuit design description 202 provides information to an analysis tool 204. The design description 202 can include transistor netlists, design netlists, design parasitic data and timing constraints associated with the circuit design. The analysis tool 204 executes a device modification and timing algorithm to optimize a circuit design. As previously discussed, the analysis tool 204 can be a static timing analysis tool, a transistor autosizer or another circuit design optimization tool.

The analysis tool 204 executes timing analysis and modifies transistor sizes and/or circuit cell configurations to optimize the circuit design without disturbing the functionality associated with the circuit design. The analysis tool 204 then generates circuit design characteristics for each associated circuit design instance. For example, the analysis tool 204 provides a node capacitance list that can be employed to derive a clock gater load list. The clock gater load list includes output drive loads or capacitance associated with a given clock gater for each of the clock gaters. The analysis tool 204 can also generate a cell list that defines the clock gater type associated with a given clock gater. A clock gater calculator 208 utilizes the clock gater type to extract clock gater characteristics for a given clock gater type from a clock gater characteristics library. The extracted characteristics and the derived clock gater load are employed to determine power for a given clock gater. This is repeated for each clock gater in the circuit design. The clock gater calculator 208 sums all of the power estimates determined for each clock gater to provide a total clock gater power (PCLKGT) to a power estimator 216.

The node capacitance list can also be employed to determine switching capacitance associated with each node of the circuit design. The node capacitance list includes the capacitance associated with each node in the circuit design. The associated capacitance of each node is based on the respective drive load at the node. A pre-generated node activity factor (AF) list is employed with the node capacitance to determine the total switching capacitance of the circuit design. The switching capacitance is a power related parameter associated with dynamic power.

The node activity factor list includes activity factors for each node. The activity factor corresponds to a toggle count of switching activity for a node normalized over a number of clock cycles. For example, functional verification can be utilized to generate an activity factor for nodes or junctures located between functional or structural blocks in the circuit design. The activity factor list can then be stored in a list or table to be employed to calculate the total switching capacitance of one or more circuit design instances associated with the circuit design.

The activity factor can be indicative of behavioral operating characteristics (e.g., switching activities, signal activities) and/or electrical operating characteristics (e.g., voltage, current, component values), or other characteristics of the circuit design for which the simulation is being implemented. In one particular implementation, the activity factor can include information indicative of node-level switching activities for the circuit design, such as provided by functional verification simulation. The node level switching activity can be employed to derive the activity factor for corresponding nodes.

A switching capacitance calculator 210 can determine the total switching capacitance (TOTALSWCAP) for the circuit design. The switching capacitance for a node is substantially equal to the activity factor (AF) for a given node multiplied by the node capacitance (CAPNODE) for that node such the total switching capacitance can be evaluated by the switching capacitance calculator 210 as follows:

$${TOTAL}_{SWCAP} = {\sum }_{i = 1}^{i = k} {AF}_{i} * {CAP}_{{NODE}_{i}} \qquad EQ . 1$$

where i is an integer from 1 to k and k is the number of nodes in the circuit design. The switching capacitance calculator 210 then provides the total switching capacitance to a power estimator 216.

The analysis tool 204 also provides crossover current related characteristics or parameters associated with channel connected regions of the circuit design. A channel connected region is a transistor or plurality of transistors connected in series that couple the supply voltage to ground, such that a short circuit condition between supply and ground can occur during logic transitions.

For example, the crossover current related characteristics or parameters can include the input voltage slope (VS) at the input of, and capacitive load (CL) at the output of a corresponding channel connected region, which is provided to a crossover current calculator 212. The input voltage slope and capacitive load list information is typically employed to determine delay associated with circuit devices (e.g., transistor devices, cell devices). The crossover current is current that is associated with short circuit current of devices in the circuit design. For example, in an inverter device comprised of a pull up transistor and a pull down transistor, there is a small amount of time when both the pull up and the pull down transistor are on, shorting the supply voltage to ground. The current flowing through the pull up and pull down transistors during this time period is referred to as the crossover current. The dynamic power is therefore a function of the crossover current.

The crossover current related parameters can also include device gate widths (e.g., p-type devices, n-type devices). The crossover current calculator 212 evaluates the crossover current for a plurality of channel connected regions employing the input voltage slope, capacitive load, device widths and respective crossover equations associated with respective channel connected regions in the circuit design to determine a total crossover current (TOTAL_{CROSS}). The total crossover current TOTAL_{CROSS} is provided to the power estimator 216.

The analysis tool 204 also provides a device property list. The device property list includes information relating to the gate widths associated with p-type device, n-type devices, HVT devices, and LVT devices. A leakage current calculator 214 employs the device property list with one or more predetermined leakage coefficients to determine a total leakage current (TOTAL_{LEAKAGE}). The one or more leakage coefficients are determined by characterizing transistor MOSFET devices employing SPICE characteristics associated with transistor types (e.g., HVT p-type, HVT n-type, LVT p-type, LVT n-type). The one or more leakage coefficients can be multiplied by the device widths to provide a leakage power estimate.

The leakage power estimate includes a first leakage estimate associated with gate tunneling current and a second leakage current estimate associated with source-to-drain leakage. The first leakage estimate for gate tunneling current utilizes gate widths and leakage coefficients for p-type devices and gate widths and leakage coefficients for n-type devices. The second leakage estimate for source-to-drain leakage employs gate widths and leakage coefficients for HVT type devices and gate widths and leakage coefficients for LVT type devices.

The power estimator 216 receives the total switching capacitance (TOTAL_{SWCAP}), the total crossover current (TOTAL_{CROSS}) and the total leakage (TOTAL_{LEAKAGE}). The power estimator 216 also utilizes the circuit supply voltage (V_{SUPPLY}) and the chip frequency (f) of the circuit clock. The total switching capacitance (TOTAL_{SWCAP}), the total crossover current (TOTAL_{CROSS}), the supply voltage (V_{SUPPLY}) and the chip frequency (f) are employed to determine a total switching power. The total leakage current (TOTAL_{LEAKAGE}) and the supply voltage are employed to determine a total leakage power. The total circuit power is determined by adding the total switching power to the total leakage power.

In one embodiment of the invention, the power estimator 216 determines the total switching power by evaluating the following equation:
P_{SWITCHING}=C_{SWITCHING}* V_{SUPPLY}²*f+I_{CROSSOVER}* V_{SUPPLY} EQ. 2

where C_{SWITCHING} is the total switching capacitance (TOTAL_{SWCAP}), V_{SUPPLY} is the supply voltage of the circuit design, f is the frequency of the circuit clock, and I_{CROSSOVER} is the total crossover current (TOTAL_{CROSS}). The power estimator 216 determines the total leakage power by evaluating the following equation:
P_{LEAKAGE}=I_{LEAKAGE}*V_{SUPPLY} EQ. 3

where I_{LEAKAGE} is the total leakage current (TOTAL_{LEAKAGE}) and the total circuit power is determined by the power estimator 216 as follows:
P_{TOTAL}=P_{SWITCHING}+P_{LEAKAGE}+P_{CLKGT} EQ. 4

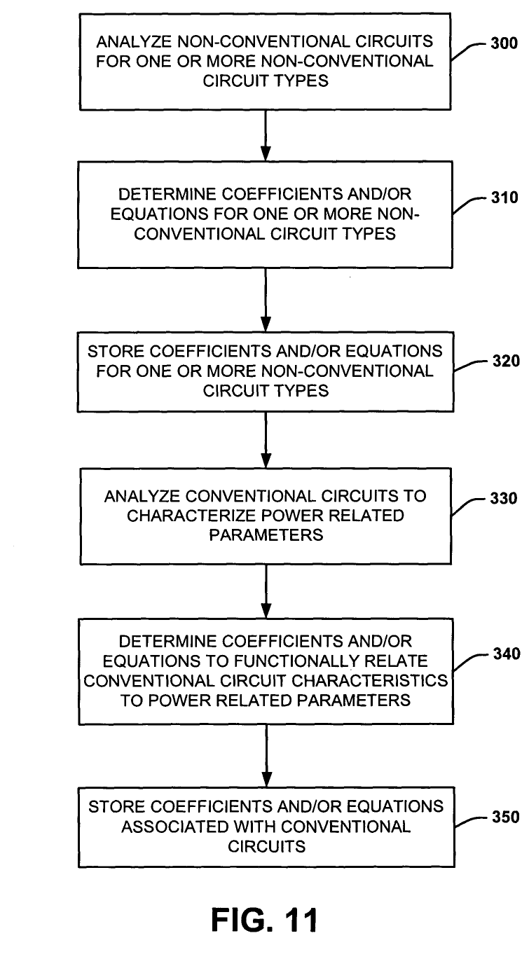

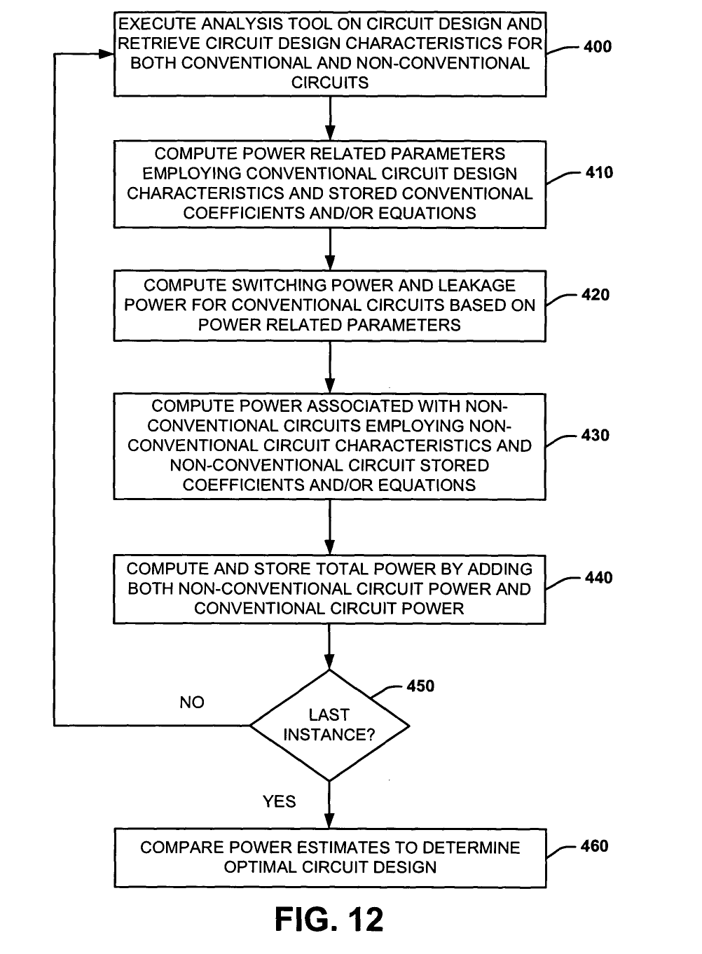

In view of the foregoing structural and functional features described above, methodologies in accordance with an embodiment of the present invention, will be better appreciated with reference to FIGS. 11-12. While, for purposes of simplicity of explanation, the methodologies of FIGS. 11-12 are shown and described as being implemented serially, it is to be understood and appreciated that the present invention is not limited to the illustrated order, as some embodiments could, in accordance with the present invention, occur in different orders and/or concurrently with other embodiments from that shown and described. Moreover, not all illustrated features may be required to implement a methodology in accordance with an embodiment of the present invention. It is to be further understood that the following methodology can be implemented in hardware, software (e.g., computer executable instructions), or any combination thereof. The software can be executed in a computer readable medium and/or can be executed on a computer.

FIG. 11 illustrates a methodology for characterizing non-conventional and conventional circuits of a circuit design in accordance with an embodiment of the present invention. The methodology begins at 300 in which non-conventional circuit designs are analyzed to characterize power as a function of output load for each non-conventional circuit type. For example, simulation and analysis of non-conventional circuits (e.g., clock gaters) are difficult. Therefore, power for these types of circuits can be estimated based on the output load or capacitive output load that these types of circuits drive. Other circuit design characteristics in addition to output load can be employed to characterized non-conventional circuits.

At 310, coefficients and/or equations are determined that functionally relate power of a given non-conventional circuit type as a function of output drive for each non-conventional circuit type. The determined coefficients and/or equations are stored for each non-conventional circuit type at 320. It is to be appreciated that a given non-conventional circuit type can also include a number of types. For example, a variety of clock gater types can be provided in a circuit design with different characterizations of power versus output drive load.

At 330, conventional circuits associated with a circuit design are analyzed to characterize power as a function of leakage and switching power related parameters. The circuit design can be analyzed by employing one or more analysis tools (e.g., timing tool, optimization tool, power estimation tool, spice characterizations). The leakage current power related parameters can include both gate tunneling leakage and source-to-drain leakage of transistor devices. The switching power related parameters can include both switching capacitance and crossover current. At 340, coefficients and/or equations are determined to functionally relate circuit design characteristics to power related parameters generated by an analysis tool. The determined coefficients and/or equations for both linkage and static power associated with conventional circuits are then stored in at 350.

FIG. 12 illustrates a methodology for estimating power in accordance with an embodiment of the present invention. The methodology begins at 400 in which an analysis tool is executed on a circuit design for a given circuit design instance to retrieve circuit design characteristics. The circuit design characteristics include circuit design characteristics associated with both non-conventional and conventional circuits in the circuit design. At 410, power related parameters are computed for conventional circuits associated with the respective circuit design instance employing the conventional circuit design characteristics and the stored coefficients and/or equations.

For example, the conventional circuit design characteristics can include node capacitance and the stored coefficients and/or equations can be activity factors associated with each node. The node capacitance and associated activity factor can be employed to determine the switching capacitance associated with the circuit design. The circuit design characteristics can also include input slope, capacitive load and device gate width information corresponding to channel connected regions, such that crossover equations can be employed to determine crossover current associated with channel connected regions of the circuit design.

The conventional circuit design characteristics can also include transistor gate widths for HVT p-type and n-type devices and LVT p-type and n-type devices. The p-type devices and n-type devices along with p-type and n-type device coefficients can be employed to determine gate tunneling leakage. The HVT type devices and LVT type devices along with HVT type and LVT type device coefficients can be employed to determine source-to-drain leakage. The source-to-drain leakage and the gate tunneling leakage can be summed together to determine total leakage of the circuit design instance.

At 420, the total switching power and the total leakage power is computed based on the power related parameters. The crossover current and the switching capacitance are power related parameters that can be employed to compute total switching power for a given circuit design instance by evaluating EQ. 2 above. The total leakage current is a power related parameter that can be employed to compute total leakage power by evaluating EQ. 3 above. The methodology then proceeds to 430.

At 430, power is computed for non-conventional circuits employing non-conventional circuit characteristics and non-conventional circuit stored coefficients and/or equations. For example, output drive loads can be computed for each non-conventional circuit employing the node capacitance list and a cell list defining the type of non-conventional circuit. Pre-computed coefficients and/or equations for each given non-conventional circuit type that functional relate power as a function of output load can be employed to determine power consumption for a given non-conventional circuit utilizing the computed output drive load. The total non-conventional circuit power can be computed by summing the calculated powers for all of the non-conventional circuits in the circuit design instance. The total power can be determined by adding the total leakage power and the total switching power associated with the conventional circuits and the total non-conventional circuit power by evaluating EQ. 4 above.

At 450, the methodology determines if the power for the last circuit design instance has been computed. If power for the last circuit design instance has not been computed (NO), the methodology returns to 400 to compute power for the next circuit design instance. If power for the last circuit design instance has been computed (YES), the methodology proceeds to 460. At 460, power estimates for a plurality of circuit design instances are compared to determine an optimal circuit design.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A power estimation system, comprising:
a predetermined power characterization associated with at least one non-conventional circuit of a circuit design that relates power as a function of output drive load for a given non-conventional circuit; and
a power estimator computes power associated with the least one non-conventional circuit based on the predetermined characterization and a derived output drive load.

2. The system of claim 1, the at least one non-conventional circuit being a clock gater.

3. The system of claim 1, further comprising a plurality of pre-determined power characterizations associated with respective non-conventional circuit type.

4. The system of claim 3, the respective predetermined power characterizations stored in a library, and the output drive load for each non-conventional circuit in the circuit design being derived employing a node capacitance list associated with a given circuit design instance.

5. The system of claim 3, the plurality of non-conventional circuit types being a plurality of clock gater types.

6. The system of claim 1, the output drive load for the at least one non-conventional circuit being derived employing node capacitance associated with a plurality of devices that are connected to an output of the at least one non-conventional circuit.

7. The system of claim 1, the power estimator computes power associated with at least one conventional circuit and adds the power associated with the at least one conventional circuit to the computed power associated with the least one non-conventional circuit to provide a total power estimate.

8. The system of claim 7, the power estimator computes power associated with the least one conventional circuit employing predetermined power characterizations that functionally relate switching power and leakage power to power related parameters.

9. The system of claim 8, the power related parameters comprising switching node capacitance and crossover current associated with switching power and leakage current associated with leakage power.

10. The system of claim 9, the switching power being computed employing a predetermined activity factor list and a node capacitance list associated with the at least one conventional circuit, the crossover power being computed employing predetermined crossover current equations and respective device gate widths, input voltage slopes and capacitive load parameters associated with a channel connected region associated with the at least one conventional circuit, and the leakage power being computed employing at least one predetermined leakage coefficient and the transistor gate area associated with the at least one conventional circuit.

11. The system of claim 1, the predetermined characterization being determined by analyzing a spice characterization of the given non-conventional circuit to correlate power as a function of output drive load.

12. A system for estimating power for a circuit design, the system comprising:
a clock gater calculator that determines power consumed by at least one clock gater in a circuit design employing at least one predetermined characterization that correlates power as a function of output drive load for a given clock gater circuit; and
a power estimator that adds power associated with at least one conventional circuit of the circuit design to the power determined by the clock gater calculator to provide a total power associated with the at least one clock gater and the at least one conventional circuit.

13. The system of claim 12, the clock gater calculator determines power associated with a plurality of clock gater types by evaluating a corresponding functional relationship of power as a function of output drive load for each of the plurality of clock gater types.

14. The system of claim 12, the clock gater calculator derives an output drive load associated with a corresponding clock gater by parsing a node capacitance list associated with a circuit design instance.

15. The system of claim 12, the clock gater calculator determines power associated with a plurality of clock gaters by adding power determined for each of the respective clock gaters of the plurality of clock gaters.

16. A power estimation system, comprising:
means for determining power associated with non-conventional circuits in a circuit design based on a predetermined characterizations that relate power as a function of output drive load for each of a given non-conventional circuit type;
means for determining power associated with conventional circuits in the circuit design; and
means for computing total power of a circuit design based on the determination of power associated with non-conventional circuits and conventional circuits in the circuit design.

17. The system of claim 16, the non-conventional circuit types being clock gaters.

18. The system of claim 16, the means for determining power associated with non-conventional circuits further comprising means for deriving an output drive load associated with at least one non-conventional circuit.

19. A power estimation method for a circuit design, comprising:
computing power associated with at least one non-conventional circuit employing a predetermined characterization of power as a function of circuit design characteristics associated with the at least one non-conventional circuit;
computing power associated with conventional circuits employing circuit design characteristics associated with conventional circuits; and
determining total circuit design power based on the computed power associated with non-conventional circuits and conventional circuits.

20. The method of claim 19, the non-conventional circuits comprising at least one clock gater device.

21. The method of claim 19, further computing power associated with a plurality of non-conventional circuit types based on a plurality of pre-determined characterizations for a plurality of non-conventional circuit types, such that each non-conventional circuit type is associated with a respective predetermined characterization.

22. The method of claim 19, the pre-determined characterizations for non-conventional being a pre-determined characterization of power as a function of output drive load.

23. The method of claim 19, further comprising:
computing at least one switching power related parameter associated with conventional circuits based on a first set of circuit design characteristics and a first predetermined characterization of switching power related parameters as a function of the first set of circuit design characteristics;
computing at least one leakage power parameter associated with conventional circuits based on a second set of circuit design characteristics and a predetermined characterization of leakage power related parameters as a function of the second set of circuit design characteristics; and
computing power associated with conventional circuits employing the at least one switching power related parameter and the at least one leakage power related parameter.

24. The method of claim 19, further comprising:
executing an analysis tool for a plurality of circuit design instances;
computing a plurality of power estimates associated with the plurality of circuit design instances; and
comparing the power estimates to determine an optimal circuit design.

25. The method of claim 19, the non-conventional circuits being a circuit that employs drive fight.

26. A computer-readable medium having computer-executable instructions for performing the method of claim 19.
